(19) United States
(12) Patent Application Publication
(10) Pub. No.: US 2012/0076403 A1
(43) Pub. Date: Mar. 29, 2012

(54) SYSTEM AND METHOD FOR ALL-IN-FOCUS IMAGING FROM MULTIPLE IMAGES ACQUIRED WITH HAND-HELD CAMERA

(76) Inventors: Oscar Nestares, San Jose, CA (US); Jianping Zhou, Fremont, CA (US); Yoram Gat, Palo Alto, CA (US)

(21) Appl. No.: 12/888,684

(22) Filed: Sep. 23, 2010

(51) Int. Cl. G06K 9/00

(52) U.S. Cl. 382/167

(57) ABSTRACT

Methods and systems to create an image in which objects at different focal depths all appear to be in focus. In an embodiment, all objects in the scene may appear in focus. Non-stationary cameras may be accommodated, so that variations in the scene resulting from camera jitter or other camera motion may be tolerated. An image alignment process may be used, and the aligned images may be blended using a process that may be implemented using logic that has relatively limited performance capability. The blending process may take a set of aligned input images and convert each image into a simplified Laplacian pyramid (LP). The LP is a data structure that includes several processed versions of the image, each version being of a different size. The set of aligned images is therefore converted into a corresponding set of LPs. The LPs may be combined into a composite LP, which may then undergo Laplacian pyramid reconstruction (LPR). The output of the LPR process is the final blended image.

### BACKGROUND

When capturing an image with a camera, focus is typically achieved at a single depth. Given a scene that includes a single object in front of a background, for example, the camera may focus on the object in the foreground (leaving the background blurry), or on the background (leaving the foreground object blurry).

In certain situations, however, it may be desirable to have an image in which more than one object appears to be in focus. It may even be desirable for everything in the same image to appear in focus. In the past, this has required taking multiple images of the same scene, where each image has a different focal depth. This has also required the use of a stationary camera. This results in multiple images, where different objects in the scene may be in the same position in each image. The multiple images may then be blended, such that all the in-focus elements of the scene may be combined in a single image.

This approach has proven to be problematic for several reasons. First, the use of a stationary camera is not always feasible. While the use of a tripod, for example, may be desirable, in practice such an arrangement is not always available. Often the camera is held by hand, such that the camera may move or jitter from moment to moment. Second, the blending process has traditionally involved complex algorithms that require significant processing power.

### BRIEF DESCRIPTION OF THE DRAWINGS/FIGURES

FIG. 1 is a flow chart illustrating the overall processing of an embodiment.

FIG. 2 is a flow chart illustrating an alignment process, according to an embodiment.

FIG. 3 is a flow chart illustrating the estimation of Euler angles, according to an embodiment.

FIG. 4 is a flow chart illustrating the blending process, according to an embodiment.

FIG. 5 is a data flow diagram illustrating the construction of a Laplacian pyramid, according to an embodiment.

FIG. 6 is a flow chart illustrating the reduction process, according to an embodiment.

FIG. 7 a flow chart illustrating the expansion process, according to an embodiment.

FIG. 8 is a data flow diagram illustrating the Laplacian pyramid reconstruction process, according to an embodiment.

FIG. 9 is a block diagram illustrating a software or firmware implementation of an embodiment.

In the drawings, the leftmost digit(s) of a reference number identifies the drawing in which the reference number first appears.

### DETAILED DESCRIPTION

An embodiment is now described with reference to the figures, where like reference numbers indicate identical or functionally similar elements. Also in the figures, the leftmost digit of each reference number corresponds to the figure in which the reference number is first used. While specific configurations and arrangements are discussed, it should be understood that this is done for illustrative purposes only. A person skilled in the relevant art will recognize that other configurations and arrangements can be used without departing from the spirit and scope of the description. It will be apparent to a person skilled in the relevant art that this can also be employed in a variety of other systems and applications other than what is described herein.

Disclosed herein are methods and systems to create an image in which objects at different focal depths may all appear to be in focus. In an embodiment, all objects in the scene may appear in focus. Non-stationary cameras may be accommodated, so that variations in the scene resulting from jitter or other motion may be tolerated. An image alignment process may be used, and the aligned images may be blended using a process that may be implemented using logic that has relatively limited performance capability. The blending process may take a set of aligned input images and convert each image into a Laplacian pyramid (LP). The LP for an image is a data structure that includes several processed versions of the image, each version being of a different size. The set of aligned images may therefore be converted into a set of LPs. The LPs may be combined into a composite LP, which then undergoes Laplacian pyramid reconstruction (LPR). The output of the LPR process is the final blended image.

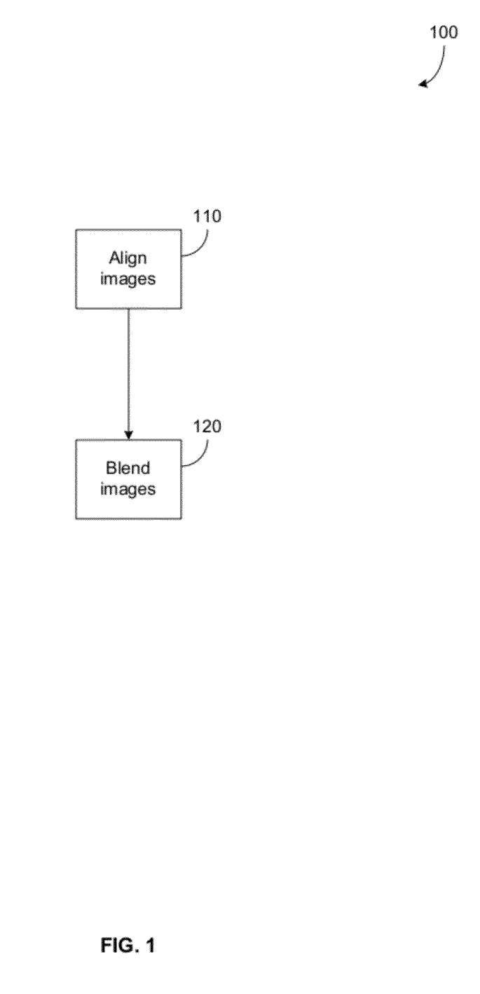

Overall processing is illustrated in FIG. 1, according to an embodiment. At 110, two or more images may be aligned. At 120, the aligned images may be blended. Embodiments of both 110 and 120 are described in greater detail below.

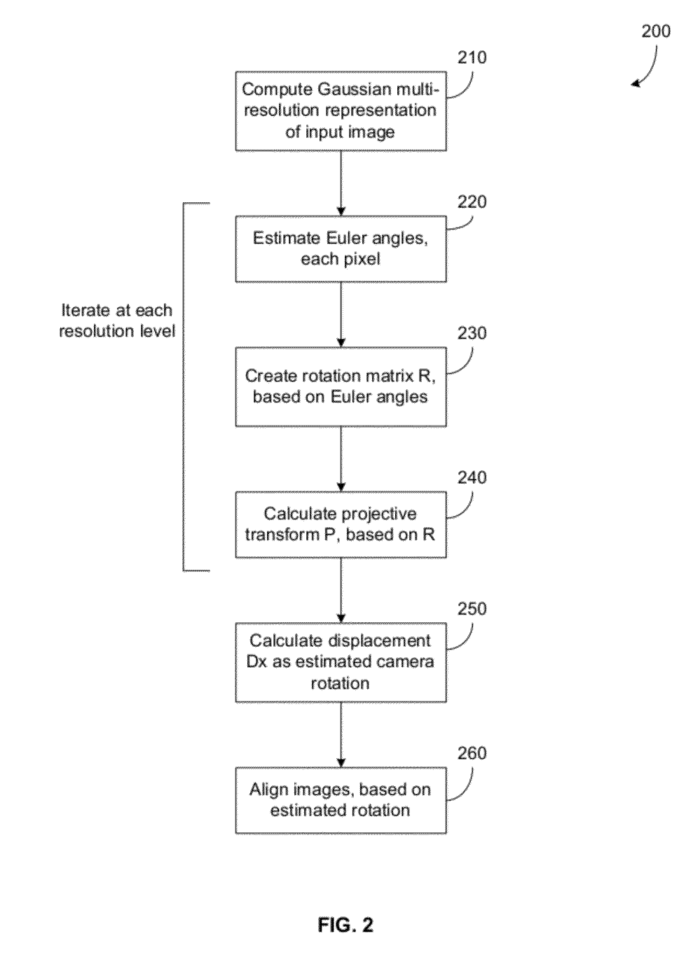

A process for estimation of camera rotation and resulting image alignment is illustrated in FIG. 2, according to an embodiment. Note that other alignment models are possible such as an affine model. At 210, a Gaussian multi-resolution representation (MRR) of the gray level representation of an input image may be calculated. Conceptually, such a representation may be viewed as a pyramid structure, wherein a first representation or pyramid layer may be a relatively coarse representation of the image, and each succeeding representation may be a finer representation of the image relative to the previous representation. This multi-resolution representation of an image may allow for a coarse-to-fine estimation strategy. In an embodiment, this multi-resolution representation of the input image may be computed using a binomial B₂ filter (¼, ½, ¼) for purposes of computational efficiency.

In the embodiment of FIG. 2, the sequence 220 through 240 may be performed for each level of the pyramid, beginning at the coarsest level. Generally, the process may be based on a gradient constraint, which assumes that the intensities between two images being aligned (or registered) are displaced on a pixel by pixel basis, while their intensity values are conserved. The gradient constraint may be stated as

dₓ(p)Iₓ(p)+d_{y}(p)I_{y}(p)+ΔI(p)=0 (1)

where I represents image intensity, d represents displacement, and ΔI(p)=I₂(p)−I₁(p), where I₂(p) and I₁(p) are the image intensities at pixel p.

Each pixel in the image may contribute one constraint and, in general, two unknowns. However, it may be assumed that camera rotation jitter may be dominating the image motion over the camera translation so that the displacement between two images can be expressed as

$$d ( p ) = ( \begin{matrix}\frac{{x}_{2 x}}{{x}_{2 z}} - {x}_{1 x} \\ \frac{{x}_{2 y}}{{x}_{2 z}} - {x}_{1 y}\end{matrix} ) ,$$

where x₁ is the location of pixel p in homogeneous image coordinates, x₂=Px₁ and boldface P is a particular projective transform that depends on three parameters describing the 3D camera rotation and the two focal lengths of the images (assuming a simple diagonal camera calibration matrix):

$${x}_{2} = P {x}_{1} , P = ( \begin{matrix}{f}_{1} & 0 & 0 \\ 0 & {f}_{1} & 0 \\ 0 & 0 & 1\end{matrix} ) R ( \begin{matrix}1 / {f}_{2} & 0 & 0 \\ 0 & 1 / {f}_{2} & 0 \\ 0 & 0 & 1\end{matrix} ) \qquad ( 2 )$$

where f₁ and f₂ are the respective focal lengths, and R is the 3D rotation matrix corresponding to the camera rotation. The rotation matrix may be parametrized using Euler angles ω=(ωₓ, ω_{y}, ω_{z}) corresponding to an (x, y, z) convention. A small angle approximation may be used,

$$R \approx ( \begin{matrix}1 & - {ω}_{z} & {ω}_{y} \\ {ω}_{z} & 1 & - {ω}_{x} \\ - {ω}_{y} & {ω}_{x} & 1\end{matrix} ) \qquad ( 3 )$$

When combining (1), (2), and (3), the following constraint may be obtained at each pixel:

$${ω}_{x} [ - {I}_{x} \frac{xy}{{f}_{2}} - {I}_{y} ( {f}_{1} + \frac{{y}^{2}}{{f}_{2}} ) + Δ I \frac{y}{{f}_{2}} ] + {ω}_{y} [ {I}_{x} ( {f}_{1} + \frac{{x}^{2}}{{f}_{2}} ) + {I}_{y} \frac{xy}{{f}_{2}} - Δ I \frac{x}{{f}_{2}} ] + {ω}_{z} [ \frac{f 1}{f 2} ( - {I}_{x} y + {I}_{y} x ) ] + ( \frac{f 1}{f 2} - 1 ) ( {I}_{x} x + {I}_{y} y ) + Δ I = 0 \qquad ( 4 )$$

Assuming that the focal lengths of both images are provided by the camera, this constraint is linear in the Euler angles vector ω.

At 220, each iteration may begin by gathering constraints from a sampling of pixels from a first input image. The locations from which the constraints are formed may be chosen using a rectangular sampling grid in the frame of reference of the first input image, according to an embodiment. Given these pixels and their constraints, a vector ω may be estimated for each pixel. The process for estimating these angles, according to an embodiment, will be discussed in greater detail below.

Given the resulting estimations of the Euler angles, at 230 a rotation matrix R may be determined according to (3) above. After this matrix is determined, at 240 the projective transform P may be calculated according to (2) above. With each iteration, the transform P may be combined with the transform P that resulted from the previous iteration, or from the previous resolution level.

At 250, the displacement d(p) may be calculated as the estimated interframe camera rotation. At 260, the input frame and its succeeding frame may be aligned according to the estimated camera rotation. In an embodiment, bilinear interpolation may be used to obtain the displaced intensity values of the succeeding image at the identified pixel locations.

In an embodiment, it may be desirable to avoid problems caused by sudden changes in exposure. Such problems are sometimes introduced by the auto-exposure feature of cameras. To avoid such problems, the images may be pre-processed to equalize their mean and standard deviation prior to the alignment.

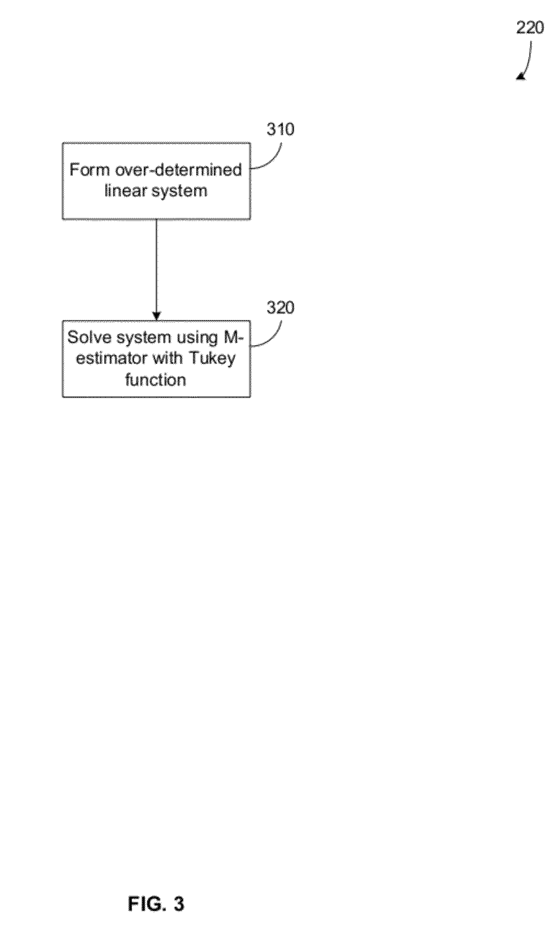

FIG. 3 illustrates the estimation of Euler angles (220 above) in greater detail. At 310, a constraint of the form of equation (4) may be created for each sampled pixel at the given resolution level. This results in an equation for each sampled pixel. The resulting set of equations represents an over-determined system of equations that are each linear in ω. At 320, this system of equations may be solved. In the illustrated embodiment, the system may be solved using an M-estimator with a Tukey function.

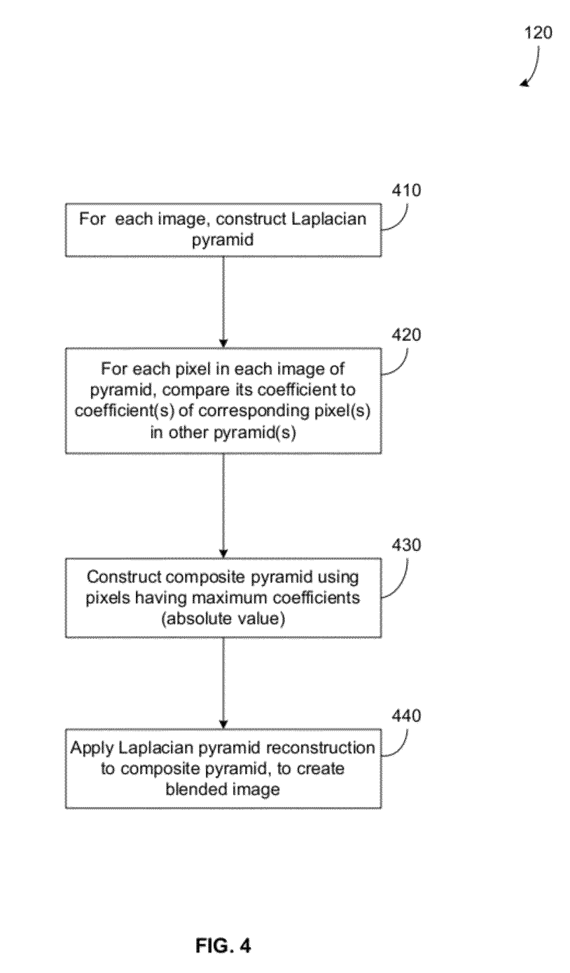

The blending process (120 of FIG. 1) is shown in greater detail in FIG. 4, according to an embodiment. At 410, a Laplacian pyramid may be constructed for each aligned image and for each color channel or, alternatively, for the intensity and two color channels of an appropriate color components representation. This construction will be described in greater detail below. Generally speaking, a Laplacian pyramid of an input image is a set of images derived from the input image. The derivation of these images includes linear filtering of the input image, followed by iterative reduction and expansion of the filtered input image. The resulting set of images includes images of varying sizes, so that conceptually they may be collectively modeled as a pyramid.

At 420 and 430, the Laplacian pyramids of the input images may be used to construct a composite Laplacian pyramid. At 420, for each pixel of an LP, the pixel's coefficient may be compared to that of the corresponding pixels in the other LPs. Of this set of corresponding pixels, the pixel having the largest absolute value for its coefficient may be saved and used in the corresponding position in the composite pyramid. At 430, the composite pyramid may thus be constructed from these saved pixels. Each pixel in the composite pyramid represents the pixel having the largest coefficient (in absolute value) of all the corresponding pixels at respective comparable locations in the set of LPs.

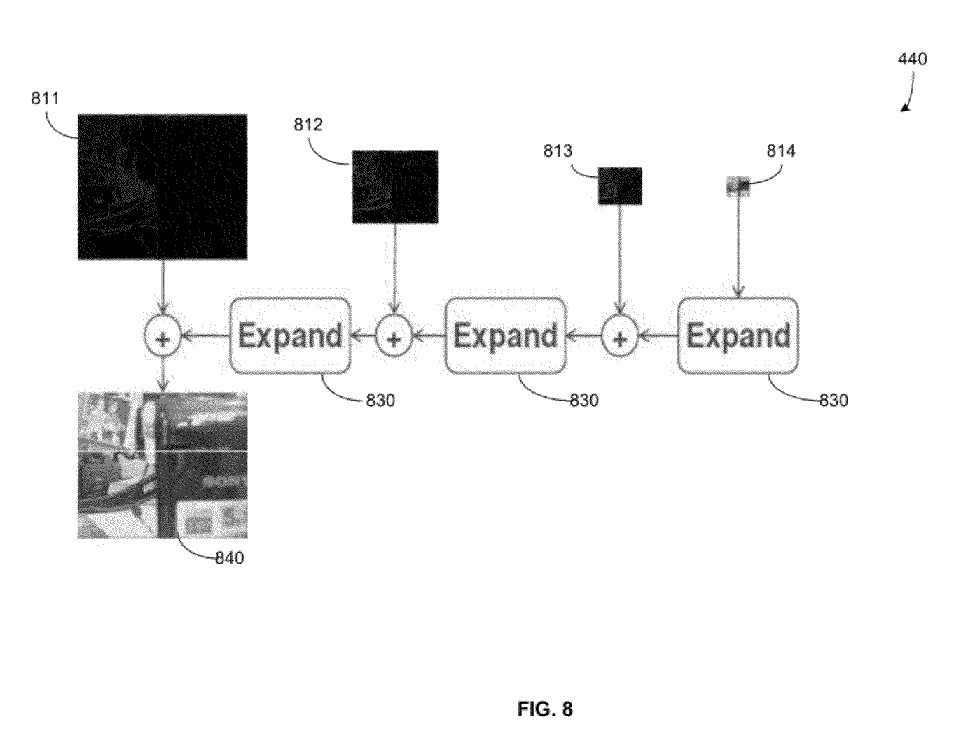

At 440, the composite pyramid undergoes Laplacian pyramid reconstruction to create the final blended image. This is discussed in greater detail below with respect to FIG. 8.

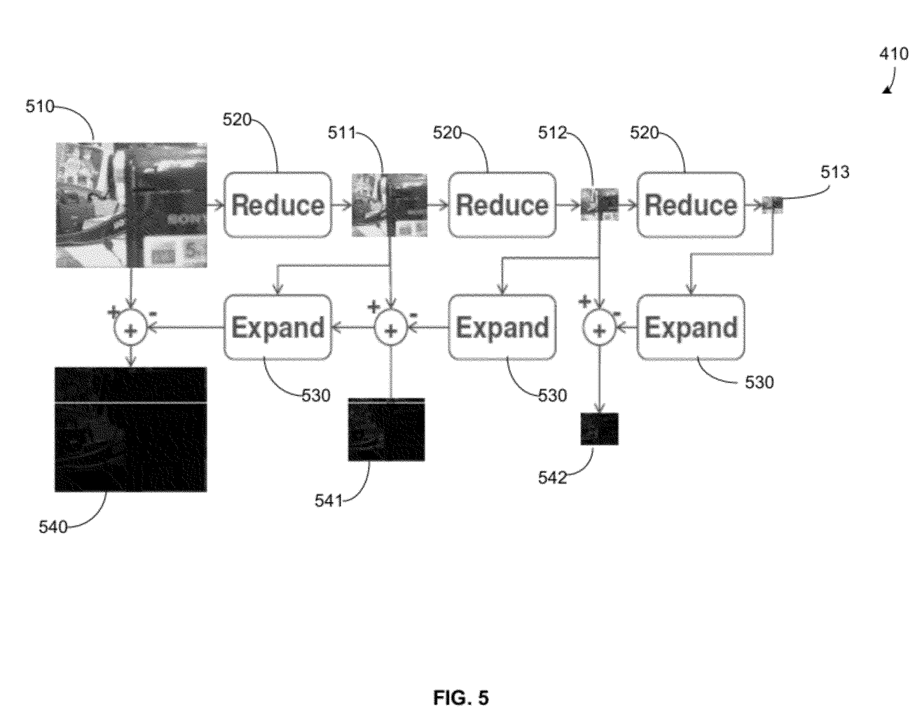

FIG. 5 illustrates the construction of a Laplacian pyramid (410 of FIG. 4). An input image 510 may be iteratively reduced by a reduction process 520. In the illustrated example, input image 510 may be reduced to form an image 511, which may then be reduced to form an image 512. Image 512 may then be reduced to form image 513. As will be described in greater detail below, reduction includes a filtering process and the elimination of certain pixels. Moreover, the example of FIG. 5 shows three reductions; in alternative embodiments, the number of reductions may be different. The chosen number of reductions may be decided at least in part by the desired size for the final reduced image (image 513 in this example).

The final reduced image 513 then undergoes an expansion process 530. The expansion process will be described in greater detail below, and includes the interleaving of all-zero representations of pixels into the image undergoing expansion, followed by a filtering process. In an embodiment, an all-zero representation of a pixel may be a binary pixel where the data is all zeros. The output of the expansion of image 513 may then be subtracted from the predecessor image of the image undergoing expansion. At this point, the output of the expansion of image 513 may be subtracted from image 512, which is the predecessor image of image 513. The result of this subtraction may be saved as difference image 542, which represents part of the eventual Laplacian pyramid.

The predecessor image 512 also undergoes expansion 530. The output of this expansion may then be subtracted from the predecessor of image 512, i.e., image 511. The result of this subtraction may be saved as difference image 541. Image 511 similarly undergoes expansion 530; the result may be subtracted from image 510 to create difference image 540, which may likewise be saved. The saved difference images 540, 541, and 542 collectively represent the Laplacian pyramid.

Note that the number of expansions is necessarily equal to the number of reductions. The illustrated example shows three expansions; other embodiments may use a different number.

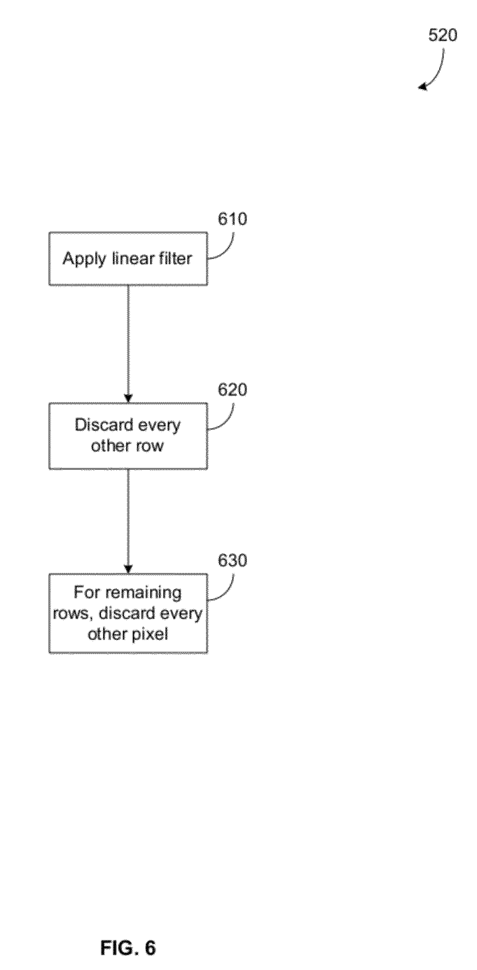

The reduction process (520 of FIG. 5) is illustrated in FIG. 6, according to an embodiment. At 610, a linear filter may be applied. In an embodiment, the filter may use the mask

$$[ \begin{matrix}1 & 2 & 1 \\ 2 & 4 & 2 \\ 1 & 2 & 1\end{matrix} ] / 16.$$

This mask is not often used to construct Laplacian pyramids because it is a coarse approximation of a Gaussian, but it may produce high quality results in this particular application at a lower cost than other of the most commonly used filters. For this reason this particular version of the Laplacian pyramid may be viewed as a simplified Laplacian pyramid.

At 620 and 630, pixels may be removed from the filtered image. At 620, every other row may be discarded. At 630, every other pixel may be removed from each of the remaining rows. The result is the reduced image.

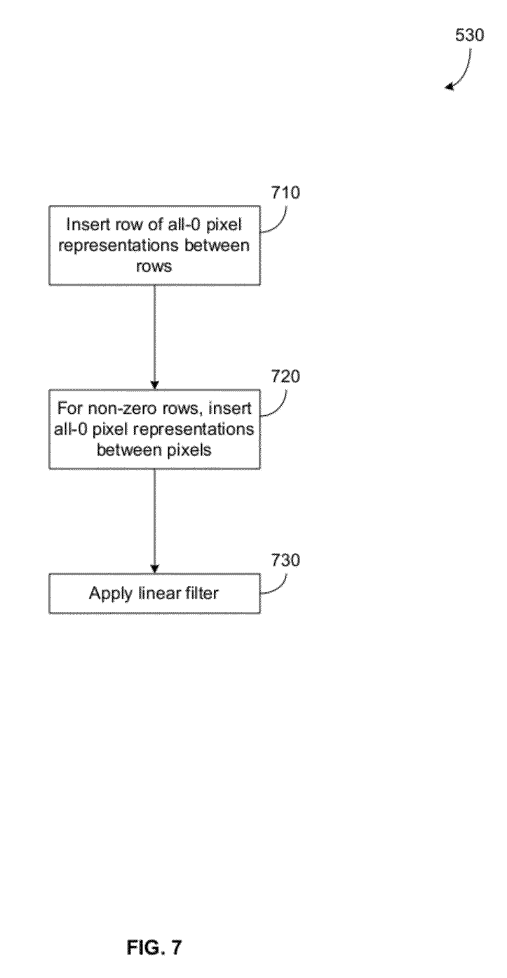

The expansion process (530 of FIG. 5) is illustrated in FIG. 7, according to an embodiment. At 710, rows of pixels may be interleaved between the existing rows of the image. These inserted pixels may be all-zero pixel representations. At 720, in the original rows, all-zero pixel representations may be interleaved with the original pixels. In these rows, the result is that every other pixel is an all-zero pixel representation. Therefore, after completion of 710 and 720, every other row will be made of all-zero pixel representations. In the other rows, every other pixel will be an all-zero pixel representation.

At 730, a linear filter may be applied. In an embodiment, the filter may use the same mask described in the reduction process for the same reasons discussed there

$$[ \begin{matrix}1 & 2 & 1 \\ 2 & 4 & 2 \\ 1 & 2 & 1\end{matrix} ] / 16.$$

Laplacian pyramid reconstruction (LPR, reference 440 of FIG. 4) is illustrated in FIG. 8, according to an embodiment. The inputs are shown as images 811-814, which are the constituents of the composite Laplacian pyramid. The smallest image 814 may be input to an expansion process 830. The expansion 830 may be the same process as expansion 520 above. The output of this expansion may then be added to the next largest input, image 813. The sum may then be expanded and added to the next largest image 812. The resulting sum may be expanded and added to the next largest image 811. The result is the final blended image 840.

While three expansions and four input images are shown, alternative embodiments may have a different number of expansions depending on the number of images in the input Laplacian pyramid.

An additional operation may be applied before comparing the coefficients for each pixel in each image of the pyramid (420 of FIG. 4). This would consist of applying a linear filter to each of the pyramid images in absolute value. In some cases this might increase the quality of the blended image at the additional computation cost of applying the linear filter. In one embodiment this filter is a 5×5 box filter.

One or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, refers to a computer program product including a non-transitory computer readable medium having computer program logic stored therein to cause a computer system to perform one or more features and/or combinations of features disclosed herein.

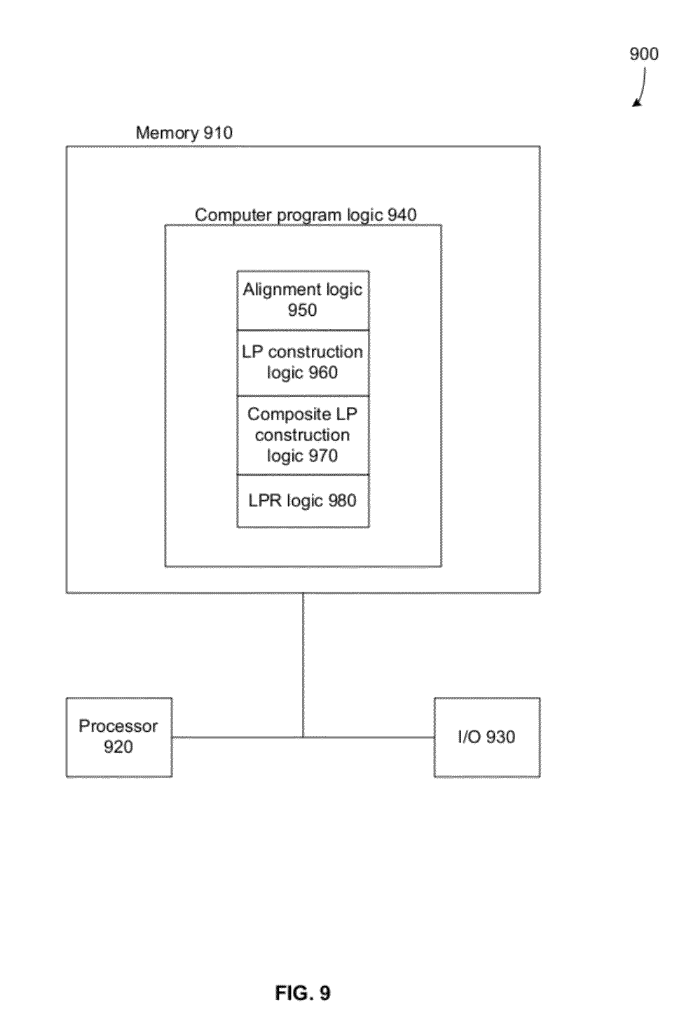

FIG. 9 illustrates a software or firmware embodiment of the processing described herein. In this figure, system 900 may include a processor 920 and may further include a body of memory 910. Memory 910 may include one or more computer readable media that may store computer program logic 940. Memory 910 may be implemented as a hard disk and drive, a removable media such as a compact disk, a read-only memory (ROM) or random access memory (RAM) device, for example, or some combination thereof. Processor 920 and memory 910 may be in communication using any of several technologies known to one of ordinary skill in the art, such as a bus. Computer program logic 940 contained in memory 910 may be read and executed by processor 920. One or more I/O ports and/or I/O devices, shown collectively as I/O 930, may also be connected to processor 920 and memory 910.

Computer program logic 940 may include alignment logic 950. Logic 950 may be responsible for aligning images of a scene for subsequent blending. Logic 950 may implementing the processing discussed above with respect to FIGS. 2 and 3.

Computer program logic 940 may also include LP construction logic 960. This module may include logic for construction of a Laplacian pyramid based on an input image, as discussed above with respect to FIGS. 5-7.

Computer program logic 940 may also include logic 970 for the construction of a composite Laplacian pyramid, as discussed above with respect to reference 430 of FIG. 4.

Computer program logic 940 may also include Laplacian pyramid reconstruction logic 980. This module may include logic for the creation of a blended image as described above with respect to reference 440 of FIG. 4 and with respect to FIG. 8.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the exemplary embodiments disclosed herein.

What is claimed is:

1. A method, comprising:
aligning a plurality of images of the same scene, where different images have different objects in focus; and
blending the aligned images, said blending comprising:
for each image, constructing a Laplacian pyramid representing the image for each of the color components of the image in an appropriate color component representation;
constructing a composite Laplacian pyramid, based on the plurality of Laplacian pyramids corresponding to the respective plurality of images; and
performing Laplacian pyramid reconstruction on the composite Laplacian pyramid, to create a blended image wherein the different objects that were in focus in the respective images, appear in focus in the blended image.

2. The method of claim 1, wherein said construction of a Laplacian pyramid representing an image comprises:
iteratively reducing the image and saving the reduced image resulting from each reduction, creating a series of reduced images;
expanding each reduced image, creating a series of expanded images;
subtracting each expanded image from the image that served as input to the reduction that produced the reduced image used to create the expanded image, resulting in a set of difference images; and
using the difference images to create the Laplacian pyramid representing the image.

3. The method of claim 2, wherein said reduction of an image comprises:
applying a linear filter to the image;
discarding every other row of pixels from the filtered image; and
for the remaining rows of the filtered image, discarding every other pixel.

4. The method of claim 3, wherein said expansion of an image comprises:
in each row, interleaving all-zero pixel representations between pixels in the row, so that pixels in the row alternate with all-zero pixel representations;
adding rows of all-zero pixel representations between rows of the image, so that every other row of the image is a row of all-zero pixel representations; and
applying the linear filter to the result.

5. The method of claim 4, wherein said linear filter uses a mask defined by the expression
$$[ \begin{matrix}1 & 2 & 1 \\ 2 & 4 & 2 \\ 1 & 2 & 1\end{matrix} ] / 16.$$

6. The method of claim 2, wherein said Laplacian pyramid reconstruction comprises:
expanding the smallest difference image;
adding the result of the expansion of the smallest difference image to the next largest difference image, resulting in a sum;
iteratively expanding the sum and adding the expanded sum to the next largest difference image to create a next sum, ultimately producing a final sum; and
using the final sum as the blended image.

7. The method of claim 1, wherein said constructing of a composite Laplacian pyramid comprises:
for each pixel to be defined in the composite Laplacian pyramid,
examining the corresponding pixel in each Laplacian pyramid representing an image;
choosing the pixel having the maximum absolute value from the set of corresponding pixels; and
using the chosen pixel as the pixel to be defined in the composite Laplacian pyramid.

8. A system, comprising:
a processor; and
a memory in communication with said processor, wherein said memory stores a plurality of processing instructions configured to direct said processor to
align a plurality of images of the same scene, where different images have different objects in focus; and
blend the aligned images, the blending comprising:
for each image, constructing a Laplacian pyramid representing the image for each of the color components of the image in an appropriate color component representation;
constructing a composite Laplacian pyramid, based on the plurality of Laplacian pyramids corresponding to the respective plurality of images; and
performing Laplacian pyramid reconstruction on the composite Laplacian pyramid, to create a blended image wherein the different objects that were in focus in the respective images, appear in focus in the blended image.

9. The system of claim 8, wherein said construction of a Laplacian pyramid representing an image comprises:
iteratively reducing the image and saving the reduced image resulting from each reduction, creating a series of reduced images;
expanding each reduced image, creating a series of expanded images;
subtracting each expanded image from the image that served as input to the reduction that produced the reduced image used to create the expanded image, resulting in a set of difference images; and
using the difference images to create the Laplacian pyramid representing the image.

10. The system of claim 9,
wherein the reduction of an image comprises:
applying a linear filter to the image;
discarding every other row of pixels from the filtered image; and
for the remaining rows of the filtered image, discarding every other pixel, and
wherein the expansion of an image comprises:
in each row, interleaving all-zero pixel representations between pixels in the row, so that pixels in the row alternate with all-zero pixel representations;
adding rows of all-zero pixel representations between rows of the image, so that every other row of the image is a row of all-zero pixel representations; and
applying the linear filter to the result.

11. The system of claim 10, wherein the linear filter uses a mask defined by the expression
$$[ \begin{matrix}1 & 2 & 1 \\ 2 & 4 & 2 \\ 1 & 2 & 1\end{matrix} ] / 16.$$

12. The system of claim 9, wherein the Laplacian pyramid reconstruction comprises:
expanding the smallest difference image;
adding the result of the expansion of the smallest difference image to the next largest difference image, resulting in a sum;
iteratively expanding the sum and adding the expanded sum to the next largest difference image to create a next sum, ultimately producing a final sum; and
using the final sum as the blended image.

13. The system of claim 8, wherein the construction of a composite Laplacian pyramid comprises:
for each pixel to be defined in the composite Laplacian pyramid,
examining the corresponding pixel in each Laplacian pyramid representing an image;
choosing the pixel having the maximum absolute value from the set of corresponding pixels; and
using the chosen pixel as the pixel to be defined in the composite Laplacian pyramid.

14. A computer program product including a non-transitory computer readable medium having computer program logic stored therein, the computer program logic including:
logic to cause a processor to align a plurality of images of the same scene, where different images have different objects in focus; and
logic to cause a processor to blend the aligned images, the blending comprising:
for each image, constructing a Laplacian pyramid representing the image for each of the color components of the image in an appropriate color component representation;
constructing a composite Laplacian pyramid, based on the plurality of Laplacian pyramids corresponding to the respective plurality of images; and
performing Laplacian pyramid reconstruction on the composite Laplacian pyramid, to create a blended image wherein the different objects that were in focus in the respective images, appear in focus in the blended image.

15. The computer program product of claim 14, wherein the construction of a Laplacian pyramid representing an image comprises:
iteratively reducing the image and saving the reduced image resulting from each reduction, creating a series of reduced images;
expanding each reduced image, creating a series of expanded images;
subtracting each expanded image from the image that served as input to the reduction that produced the reduced image used to create the expanded image, resulting in a set of difference images; and
using the difference images to create the Laplacian pyramid representing the image.

16. The computer program product of claim 15, wherein the reduction of an image comprises:
applying a linear filter to the image;
discarding every other row of pixels from the filtered image; and
for the remaining rows of the filtered image, discarding every other pixel.

17. The computer program product of claim 16, wherein the expansion of an image comprises:
in each row, interleaving all-zero pixel representations between pixels in the row, so that pixels in the row alternate with all-zero pixel representations;
adding rows of all-zero pixel representations between rows of the image, so that every other row of the image is a row of all-zero pixel representations; and
applying the linear filter to the result.

18. The computer program product of claim 17, wherein the linear filter uses a mask defined by the expression
$$[ \begin{matrix}1 & 2 & 1 \\ 2 & 4 & 2 \\ 1 & 2 & 1\end{matrix} ] / 16.$$

19. The computer program product of claim 15, wherein the Laplacian pyramid reconstruction comprises:
expanding the smallest difference image;
adding the result of the expansion of the smallest difference image to the next largest difference image, resulting in a sum;
iteratively expanding the sum and adding the expanded sum to the next largest difference image to create a next sum, ultimately producing a final sum; and
using the final sum as the blended image.

20. The computer program product of claim 14, wherein the constructing of a composite Laplacian pyramid comprises:
for each pixel to be defined in the composite Laplacian pyramid,
examining the corresponding pixel in each Laplacian pyramid representing an image;
choosing the pixel having the maximum absolute value from the set of corresponding pixels; and
using the chosen pixel as the pixel to be defined in the composite Laplacian pyramid.
